(19) United States
(12) Patent Application Publication
(10) Pub. No.: US 2011/0068895 A1
(43) Pub. Date: Mar. 24, 2011

(54) Control of a Vehicle Having a Passive Entry-Passive Start Function

(76) Inventors: Tom S. Gee, Canton, MI (US); William P. Perkins, Dearborn, MI (US); Jennifer D. Shaw, Plymouth, MI (US); Ryan Skaff, Farmington Hills, MI (US); John Popovecz, Waterford, MI (US)

(21) Appl. No.: 12/564,981

(22) Filed: Sep. 23, 2009

(51) Int. Cl. G06F 7/04

(52) U.S. Cl. 340/5.67

(57) ABSTRACT

A method for controlling mobilizing and immobilizing a vehicle using a valid passive entry-passive start key includes detecting that a vehicle operator exits the vehicle, determining that the key is absent from the vehicle, automatically immobilizing the vehicle by preventing vehicle propulsion; if a power source of the vehicle is immobilized after the operator exits the vehicle, automatically mobilizing the vehicle to allow vehicle propulsion when a key authorized to operate the vehicle is detected in the vehicle after a vehicle door is opened and closed, and automatically placing the vehicle in a low energy consumption operating state, if a reference period expires after the operator exits the vehicle with the power source running.

### BACKGROUND OF THE INVENTION

1. Field of the Invention

This invention relates generally to controlling mobile and immobile operation of a vehicle if an authorized driver exits the vehicle with the power source running or fails to reenter the vehicle during a prescribed period.

2. Description of the Prior Art

Passive Entry/Passive Start (PEPS) is a feature that allows a vehicle operator to enter the vehicle without actively using a key or remote transmitter, and allows the operator to start the vehicle's engine without inserting a key in an ignition switch. PEPS accomplishes this function through wireless communication between the vehicle and an authorized key, which the driver has present while entering and starting the vehicle.

The driver, however, may accidentally leave the powertrain or electrical system enabled upon exiting the vehicle, usually due to inattention. Leaving the powertrain enabled may allow the vehicle to be stolen or otherwise operated by an unauthorized driver. This is of particular concern for a vehicle whose powertrain is not audible or otherwise undetectable while operating, e.g. hybrid electric vehicle, battery electric vehicle, automatic start/stop vehicle. It may also allow the vehicle to continue running until it runs out of fuel, stranding the driver upon return. Leaving the electrical system enabled may drain the electric storage battery.

A need exists for a method that reliably performs the PEPS function, yet prevents unauthorized operation of the vehicle and also prevents the vehicle from consuming all its fuel or draining its the battery while left running and unattended.

### SUMMARY OF THE INVENTION

A method for controlling mobilizing and immobilizing a vehicle using a valid passive entry-passive start key includes detecting that a vehicle operator exits the vehicle, determining that the key is absent from the vehicle, automatically immobilizing the vehicle by preventing vehicle propulsion, automatically mobilizing the vehicle to allow vehicle propulsion when a key authorized to operate the vehicle is detected in the vehicle after a qualifying driver detection event, e.g. vehicle door is opened and closed, and automatically placing the vehicle in a low energy consumption operating state, if a reference period expires after the operator exits the vehicle with the power source running.

Upon detecting the vehicle operator's exit and disabling the vehicle's electrical and/or propulsion system, the method prevents unauthorized vehicle operation and keeps the vehicle from running out of fuel or excessively discharging its battery, thereby avoiding stranding the driver.

The system transitions automatically to immobilized vehicle mode, if the driver exits the vehicle while leaving the power source running or enabled. When a timer expires, a controller automatically shuts down the vehicle if the driver doesn't reenter within a set period.

These features improve the PEPS function's security and customer convenience by reducing the likelihood that an unauthorized driver operates the vehicle and eliminating the occurrence of the vehicle running out of fuel or battery charge, if the driver leaves the vehicle or its accessories running, such as with the air conditioning compressor running.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a schematic diagram showing a vehicle equipped with a Passive Entry/Passive Start system; and

FIG. 2 is diagram of the method steps for controlling mobile and immobile operation of the vehicle.

### DESCRIPTION OF THE PREFERRED EMBODIMENT

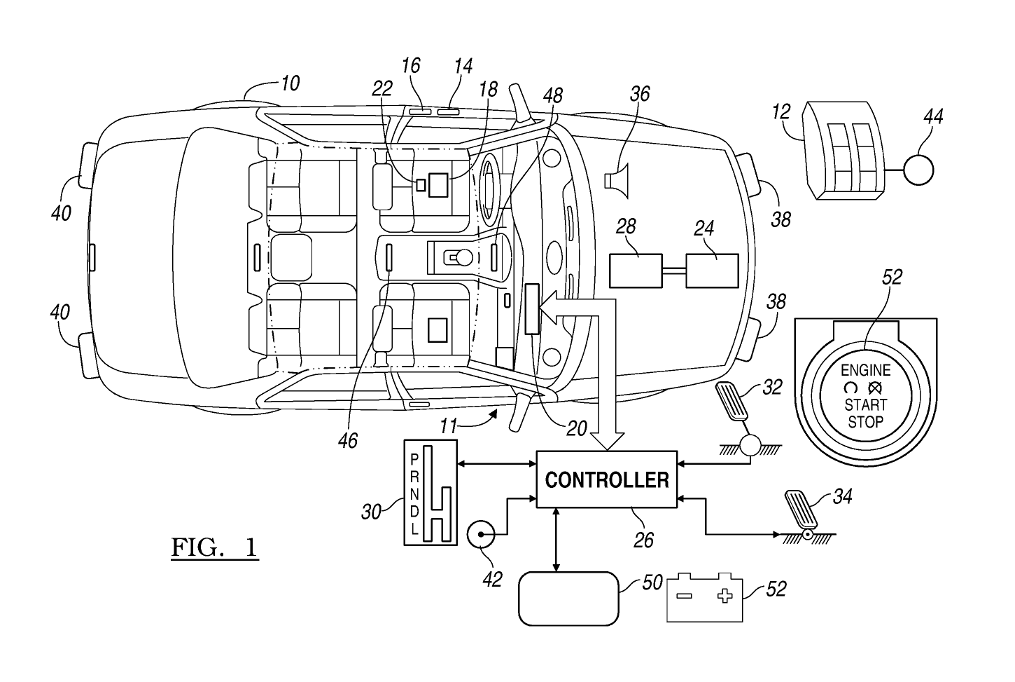

Referring now to the drawings, there is illustrated in FIG. 1 a vehicle 10 equipped with a Passive Entry/Passive Start (PEPS) system 11. The system unlocks the doors after completing a PEPS key 12 detection procedure. The system receives a wake-up signal when a person having personal possession of a key 12 touches a keyless entry keypad or other entry trigger device such as a switch on the door handle 14, located on the outer surface of the driver-side door. In response to the wake-up signal, the PEPS system 11 transmits a low frequency, wireless challenge signal from an antenna in the door handle 16 to the key 12, which sends a high frequency wireless response to a RF receiver 18 in the vehicle. A main control module 20 receives and processes data from receiver 18 and issues a control signal causing the vehicle doors to unlock if the detected key 12 is authorized for use with the vehicle 10, determined by data in its response signal, and is located within about one meter of the door handle 16.

The PEPS system 11 also detects when the vehicle operator has exited the vehicle. If the vehicle operator has the PEPS key 12 in his personal possession, the system 11 looks for the key after completion of a driver detection event, e.g. door open-door close cycle with the vehicle below a predetermined vehicle speed or while transmission shifter is in the Park position. Other devices 22 for detecting the vehicle operator's exiting the vehicle 10 include seat sensors (often also used for occupant classification sensing in airbag and restraint systems), motion sensors (often also used for intrusion sensing in vehicle anti-theft systems), eye sensors, sound sensors, heartbeat sensors, etc. These devices 22 can be used if additional or refined functionality is desired, but a simple key search-and-detect procedure can be used to govern transitions between mobile and immobile vehicle operation.

If the power source 24, such as an engine or electric traction motor, is operating when the vehicle operator exits the vehicle, the system 11 disallows vehicle propulsion by transitioning a vehicle powertrain controller 28 to immobile operation, which may include an entire vehicle shut-down.

The vehicle operator, however, may want to exit the vehicle for a brief period without shutting down the power source 24 and other vehicle functions. For example, the vehicle operator may want to keep the vehicle running for a brief period so that the vehicle's climate control system continues to keep the cabin warm or cool. To prevent vehicle theft in this case, a controller 28 places the vehicle in an immobile operating mode, in which the power source 24 continues to run and drive vehicle accessories, but the powertrain prevents transmitting torque to the vehicle wheels sufficient to accelerate the vehicle and drive it away. This immobilization of the vehicle can be accomplished in various ways including, for example, but not limited to: (i) locking the gear selector 30 in its Park or Neutral position (using the brake-shift interlock mechanism or similar), (ii) shifting the transmission 28 to Park or Neutral gear (or other gear that prevents torque delivery to the wheels), even if the gear selector 30 is moved to a position other than the Park position, (iii) limiting powertrain output torque by restricting torque produced by the power source 24 to a magnitude that is less than required to accelerate the vehicle (e.g., the PEPS controller requests the powertrain controller to enter a non-motive operating mode), (iv) ignoring depression of the accelerator pedal 32 and cruise-control requests, preferably while engaging a park brake 34, particularly an electrically actuated parking brake. This can also be accomplished using an engine immobilizer system already equipped in the vehicle and setting that immobilizer system to non-motive mode.

Limiting powertrain output torque to a non-propulsion output torque magnitude is relatively easy to accomplish in a hybrid electric vehicle HEV having a powersplit transmission by commanding output torque to zero or near-zero. It is also relatively easy to accomplish in a conventional vehicle with electronically controlled transmission gear selection (also called “shift-by-wire”) by commanding a non-propulsion gear, or commanding an operating state that prevents propulsion torque delivery to the wheels.

Additional functionality may be provided by an alarm that is activated when an unauthorized vehicle operator attempts to drive the vehicle 10 while controller 26 is in the immobile mode, such as causing the vehicle's horn to sound or the front and rear lights 38, 40 to flash. Occupants still in the vehicle without a valid key, however, would still be able to operate non-propulsion functions, like climate control, radio, etc.

The PEPS system 11 transitions the vehicle controller 26 back to mobile operation when a vehicle operator reenters the vehicle after searching for and finding the authorized key 12 upon completion of a door open-door close cycle. If for some reason the PEPS key is not detected upon driver entry (e.g., driver enters vehicle and the key is passed to him through a window without a door open/close event), then the driver will still be able to start the vehicle through the normal start-up sequence, e.g., driver presses brake pedal and then presses START button (forcing vehicle to perform a key search, and subsequent start-up).

When the vehicle operator leaves the PEPS key 12 in the vehicle and exits without shutting down the powertrain, an unauthorized driver may enter the vehicle and drive it. However, this situation is no different than that for a non-PEPS vehicle whose vehicle operator leaves the key in the ignition and exits the vehicle, allowing an unauthorized driver to operate the vehicle. The PEPS system 11 alerts the authorized vehicle operator via chimes, an information display or a similar warning device upon exiting that the vehicle is still ON. The operator may chooses to ignore the alerts, in which case the system 11 takes no further action to interpret the driver's intention.

If the vehicle operator doesn't return to the vehicle after a countdown timer 42, set for a period of about 45 minutes (or other calibratable time), expires, the PEPS system 11 causes the vehicle to power down, i.e., enter a low energy-consumptive mode in order to save fuel, battery, and other source of onboard energy.

The system 11 avoids stranding the vehicle operator in cases where the vehicle fails to detect or is unable to detect that an authorized operator has reentered the vehicle. Such failures to detect reentry may occur due to a low charge of a battery 44 located on the PEPS key 12, RF interference, or reentry of the key 12 through a window of the vehicle 10, rather than during a door open-door close sequence. For these situations, the system 11 prompts the vehicle operator to manually insert the key 12 into a back-up key-detection slot 46, or requests the vehicle operator to enter an authorized code using the external touch-pad 14 or a center console touch-screen 48. Other devices for this purpose include biometric devices to identify the vehicle operator, cell phone authorization, SYNC voice command passwords, etc. If the vehicle has not automatically conducted a key search, then the driver can still request a key search in other acceptable ways, e.g., a normal vehicle start-up sequence. Alternatively, the vehicle could perform a key search upon any driver detection input, such as pedal position input, steering wheel input, transmission shifter input, or other HMI input.

In response to expiration of timer 42, the vehicle controller 26 turns off the vehicle's power source 24 and/or electrical system if the vehicle operator does not reenter after a prescribed period, or if the level of fuel in fuel tank 50 is below a reference level, or the state of charge (SOC) of an electric storage battery 52 reaches a reference SOC.

Recognizing that passengers remaining in the vehicle may want to keep the power source 24 running for long periods, then prior to a shut-down, the instrument panel displays a warning that vehicle shut-down is about to occur unless the driver or other occupant presses a START/STOP button 54 on the dash (or using other accepted HMI input) to reset the shut-down timer 42.

The method prevents unauthorized driving of a PEPS vehicle 10 if the authorized driver exits the vehicle without shutting it down, and further includes a shut-down method (or similar energy-conserving mode) if the driver doesn't reenter the vehicle after a prescribed period.

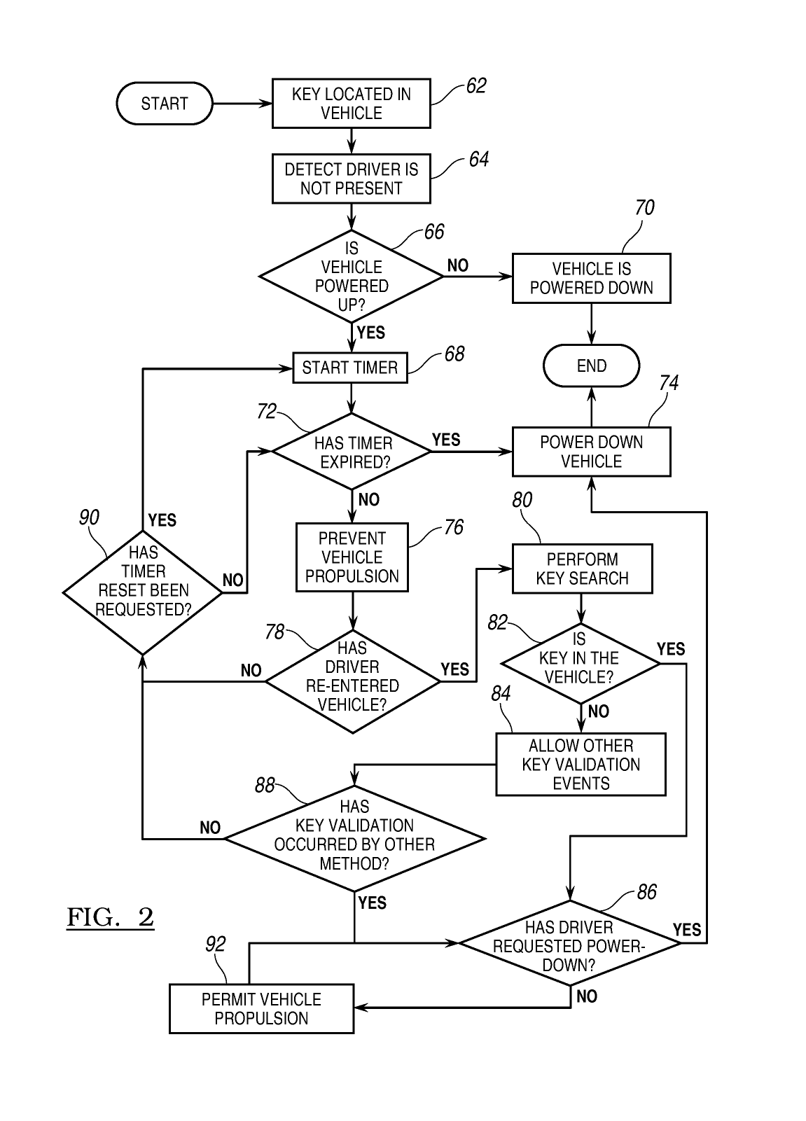

FIG. 2 illustrates the method steps, which include detecting the PEPS key 12 in the vehicle 10 at step 62, and detecting the vehicle operator's presence in the vehicle at step 64.

At step 66 a test is made to determine whether the vehicle power is ON and the propulsion system enabled. If the result of test 66 is logically positive or true, at step 68, a timer is started. If the result of 66 is false, it is determined at step 70 that the vehicle power is OFF and the vehicle propulsion system is disabled, in which case the process ends.

After step 68, a test is made at step 72 to determine if the timer has expired. If the result is true, the vehicle is turned OFF at step 74, and the process subsequently ends. If the result of step 72 is false, vehicle propulsion is disabled at step 76.

At step 78, the vehicle determines whether the driver has re-entered the vehicle. If the result is true, the vehicle performs a key search at step 80. If the result is false, a test is made at step 90 to check whether a timer reset has been requested.

After step 80, the system checks at step 82 whether the key has been detected during the key search. If the result is true, then control advances to 86. If the result is false, at step 84 the system allows other key validation events.

At step 88, the system checks whether any other key validation event has occurred. If the result is true, control advances to step 86. If the result is false, a test is made at step 90 to check whether a timer reset has been requested.

At step 86 a test is made to determine whether the driver has requested a vehicle power-down. If the result is true, control returns to step 74. If the result is false, at step 92 vehicle propulsion is permitted and control returns to step 86.

If the result of step 90 is true, then the timer is reset at step 68, and the process continues at step 72. If the result of 90 is false, then the timer is not reset, and at the process continues at step 72.

If the vehicle has been powered down, then the driver can restart the vehicle using the normal start-up procedure(s).

In accordance with the provisions of the patent statutes, the preferred embodiment has been described. However, it should be noted that the alternate embodiments can be practiced otherwise than as specifically illustrated and described.

The invention claimed is:

1. A method for controlling mobilizing and immobilizing a vehicle that operates using a valid passive entry-passive start key, comprising the steps of:
(a) detecting automatically that a vehicle operator exits the vehicle;
(b) determining automatically that the key is absent from the vehicle after a driver detection event;
(c) automatically immobilizing the vehicle by preventing vehicle propulsion, if a power source of the vehicle is enabled after the operator exits the vehicle;
(d) automatically mobilizing the vehicle to allow vehicle propulsion when a key authorized to operate the vehicle is detected in the vehicle after a driver detection event; and
(e) automatically placing the vehicle in a low energy consumption operating state, if a reference period expires after the operator exits the vehicle with the power source enabled.

2. The method of claim 1 wherein step (a) further comprises:
using at least one of a door position/door ajar sensor, seat sensor, motion sensor, pedal input sensor, steering input sensor, transmission gear shifter sensor, human machine interface sensor, vehicle speed sensor, vehicle status sensor, eye sensor, sound sensor, and heartbeat sensor to detect the exit;
performing a key search and detect function; and
failing to detect the key.

3. The method of claim 1 wherein step (b) further comprises:
automatically performing a key search and key detect procedure; and
failing to detect the key in the vehicle.

4. The method of claim 1 wherein the driver detection event of step (b) includes at least one of detecting an opening of a vehicle door, detecting a closing a vehicle door, performing a key search and validation, sensing the presence of an occupant in the vehicle, assessing vehicle speed, detecting a selection of a transmission gear, detecting a change in ignition status, detecting a change in position of a brake, accelerator or clutch pedal, and assessing status of a seat belt switch.

5. The method of claim 1 wherein step (c) further comprises:
using a powertrain controller to automatically prevent the powertrain from transmitting power from the power source to wheels of the vehicle.

6. The method of claim 1 wherein step (c) further comprises:
automatically locking a gear shifter in a Park position.

7. The method of claim 1 wherein step (c) further comprises automatically shifting the transmission to a Park gear and automatically engaging a parking pawl, while a gear shift lever is in a position other than a Park position.

8. The method of claim 1 wherein step (c) further comprises:
automatically limiting output torque of the power source to a magnitude less than required to accelerate the vehicle.

9. The method of claim 1 wherein step (c) further comprises:
causing no vehicle propulsion to occur in response to displacement of an accelerator pedal of the vehicle or an input from a device that automatically controls vehicle speed.

10. The method of claim 1 wherein step (c) further comprises engaging a parking brake of the vehicle.

11. The method of claim 1 further comprising,
while the key is located in the vehicle and if presence of the key in the vehicle is not detected automatically before the reference period expires, performing one of:
causing the vehicle to produce automatically a prompt indicating a need to manually insert the key into a back-up key-detection slot on the vehicle;
causing the key to produce automatically a prompt indicating need to enter an authorized code into one of a touch-pad or a console touch-screen located on the vehicle; and
allowing the driver to enable the propulsion system;

12. The method of claim 1 wherein step (e) further comprises:
if the vehicle is mobilized with the power source enabled when the operator exits the vehicle, automatically turning off the power source when a period of predetermined length expires.

13. The method of claim 1 wherein step (e) further comprises:
if the vehicle is mobilized with the power source enabled when the operator exits the vehicle, automatically turning off the power source when a volume of fuel in the vehicle reaches a reference volume.

14. The method of claim 1 wherein step (e) further comprises:
if the vehicle is mobilized with the power source enabled when the operator exits the vehicle, automatically turning off the power source when a state of charge of a battery reaches a predetermined state of charge.

15. The method of claim 1 wherein step (e) further comprises:
if vehicle is mobilized with the power source enabled when the operator exits the vehicle, automatically producing a warning indicating a shut-down of the power source will occur unless a button is actuated to reset a timer; and
automatically turning off the power source when the timer expires.

16. A method for controlling mobilizing and immobilizing a vehicle that operates using a valid passive entry-passive start key, comprising the steps of:
(a) detecting automatically that a vehicle operator exits the vehicle;
(b) determining automatically that the key is absent from the vehicle after driver detection event;
(c) automatically immobilizing the vehicle by preventing vehicle propulsion, if a power source of the vehicle is mobilized after the operator exits the vehicle;
(d) automatically mobilizing the vehicle to allow vehicle propulsion when a key authorized to operate the vehicle is detected in the vehicle after a driver detection event; and
(e) while the key is located in the vehicle and if presence of the key in the vehicle is not detected automatically, causing the vehicle to produce automatically a prompt indicating a need to manually insert the key into a back-up key-detection slot on the vehicle.
(f) mobilizing the vehicle to allow vehicle propulsion when a key authorized to operate the vehicle is detected in the vehicle after an authorization sequence has been initiated.

17. The method of claim 15 wherein the driver detection event of step (b) includes at least one of detecting an opening of a vehicle door, detecting a closing of a vehicle door, performing a key search and validation, sensing presence of an occupant in the vehicle, assessing vehicle speed, detecting a selection of a transmission gear, detecting a change in ignition status; detecting a change in position of a brake or accelerator pedal, and assessing status of a seat belt switch.

18. The method of claim 15 wherein step (c) further comprises:
using a powertrain controller to automatically prevent the powertrain from transmitting power from the power source to wheels of the vehicle.

19. The method of claim 1 wherein step (e) further comprises:
if vehicle is mobilized with the power source running when the operator exits the vehicle, automatically producing a warning indicating a shut-down of the power source will occur unless a button is actuated to reset a timer; and
automatically turning off the power source when the timer expires.

20. The method of claim 1 further comprising:
automatically placing the vehicle in a low energy consumption operating state, if a reference period expires after the operator exits the vehicle with the power source running.
